(19) United States
(12) Patent Application Publication
(10) Pub. No.: US 2008/0147216 A1
(43) Pub. Date: Jun. 19, 2008

(54) Secured Storage Media

(75) Inventors: Itzhak Pomerantz, Kfar Saba (IL); Eyal Bychkov, Hod Hasharon (IL)

Correspondence Address: MARK M. FRIEDMAN, C/O DISCOVEY DISPATCH , 9003 FLIRIN WAY, UPPER MARLBORO, MD, 20772, US

(73) Assignee: SANDISK IL LTD., Kfar Saba (IL)

(21) Appl. No.: 11/951,340

(22) Filed: Dec. 6, 2007

Related U.S. Application Data
(60) Provisional application No. 60/870,615, filed on Dec. 19, 2006.

(51) Int. Cl. G06F 17/00; G06F 3/048; G06F 17/30

(52) U.S. Cl. 700/94; 715/771; 707/104.1; 707/E17.001

(57) ABSTRACT

A device for associating image areas with audio recordings includes a user-programmable image holder having a touch-sensitive surface. Logic circuitry within the image holder is operative to define at least one image area and to associate the image area with an audio signal. The image area is defined, by the device, in response to physical contact applied to the image area on the touch-sensitive surface. A non-volatile memory for storing the audio signal is memory mounted within the user-programmable image holder and electrically connectable to the logic circuitry. Also provided a method for associating image areas with audio recordings using a user-programmable image holder having a touch-sensitive surface.

### CROSS-REFERENCE TO EARLIER-FILED APPLICATIONS

This patent application claims priority under 35 U.S.C. § 119(e) to U.S. Provisional Patent Application No. 60/870,615 filed Dec. 19, 2006, which is hereby incorporated by reference in its entirety.

### BACKGROUND OF THE INVENTION

Writeable media for recording and playing of audio messages are well known in the art of consumer electronics. Such media may be used in the art as greeting cards or “talking postcards” for playing prerecorded audio messages. The audio messages are typically prerecorded in these devices by an external system, such that the recipient is only allowed to hear the recorded message. Standalone talking postcards, where the recorder and the player are both embedded in the media, may be used in the art to record and replay a single, fixed message, 5 or 10 seconds in length.

When people look at a new photograph of scenery, a group of people or a complex machine, they typically browse the image and then focus their attention on an interesting part of the image. The user may then want to hear some information about the interesting part. If the sender were present the viewer would typically point a finger at the interesting part of the image, and ask a questions, such as “Tell me who is this?” or “Tell me what this is” and the sender of the image would answer “This is uncle Andy” or “This is the cooling plate that solidifies the wax”. However, when the photograph arrives by mail and the sender is not present, there is no convenient way in the prior art for the recipient to ask such questions and for the sender to verbally explain.

### SUMMARY OF THE INVENTION

In view of the prior art and the present needs, it would be desirable to have user-programmable cards enabling to flexibly record and replay audio messages in association with a desired image area on the card. The present invention may be embodied as a device for associating image areas with audio recordings and as a method thereof. The device employs a user-programmable image holder having a touch-sensitive surface. The image holder may be of any surface allowing a user to program an audio recording with a relevant image area may have a form factor of a card, such as any greeting card, post card, etc. The touch-sensitive surface may be configured to comply with a graphics tablet or as a touch-screen, outputting XY coordinates to logic circuitry for example.

A touch screen, also called a touch sensitive screen, refers herein to an interactive visual display device which the user interacts by touching the screen to select options from a displayed menu. A graphics tablet refers herein to a computer input device including a flat surface upon which the user may hand-draw images, similar to the way one draws images with a pencil and paper.

The image area may be hard copy photographic printouts that are attached to the image holder by methods typically used to attach printed photos to a photo album. Note that the image area may be a physical area on the image holder itself or may be an image area on a monitor of an external device that the device is connected to.

In one embodiment of the foregoing approach, a device for associating image areas with audio recordings may include a user-programmable image holder having a touch-sensitive surface. Logic circuitry, within the image holder, is operative to define at least one image area in response to physical contact applied to the image area on the touch-sensitive surface, and to associate the image area with an audio signal. A non-volatile memory for storing the audio signal is mounted within the user-programmable image holder and electrically connectable to the logic circuitry.

The audio signal may be user-generated or received from an external device. The touch-sensitive surface may be compatible to a touch screen or to a graphics tablet and the user-programmable image holder may have a form factor of a card.

The device may also include a recording module within the user-programmable image holder and electrically connectable to the logic circuitry. The recording module may be operative to record audio messages. The recording module may also include a microphone. The device may also include a sound playback module, within the user-programmable image holder and electrically connectable to the logic circuitry, that is operative to audibly play the audio signal. The sound playback module may include a speaker.

The device may also include a connector, such as a USB connector, that is connectable to the logic circuitry. The connector may be operative to connect the user-programmable image holder to an external device for communication therebetween. The image area may be an image area on a monitor of this external device.

In another embodiment of the foregoing approach, a method for associating image areas with audio recordings using a user-programmable image holder having a touch-sensitive surface may include defining, by the user-programmable image holder, at least one image area in response to physical contact applied to the image area on the touch-sensitive surface; receiving an audio signal for the one image area; and associating, by the user-programmable image holder, the image area with the received audio signal. The method may also include storing the audio signal, by the user-programmable image holder.

In another embodiment of the foregoing approach, a method for using a user-programmable image holder having a touch-sensitive surface may include selecting at least one image area on the user-programmable image holder, in response to physical contact applied to the image area on the touch-sensitive surface; and recording an audio message in association with the image area. The method may also include generating, by a user, the audio message. The method may also include connecting the image holder to an external device for communication therebetween.

Additional features, advantages, and possible variations of the embodiments described will become apparent from the following drawings and description.

### BRIEF DESCRIPTION OF THE DRAWINGS

For a better understanding of the various embodiments, reference is made to the accompanying drawings, in which like numerals designate corresponding sections or elements throughout, and in which:

FIG. 1 illustrates an exemplary block diagram of a device for associating image areas with audio recordings;

FIG. 2 illustrates an exemplary flow chart of a method for associating image areas with audio recordings; and

FIG. 3 illustrates an exemplary flow chart of a method for using a user-programmable image holder having a touch-sensitive surface.

### DETAILED DESCRIPTION OF THE INVENTION

The embodiments and various aspects thereof will be better understood by referring to the present detailed description of exemplary and preferred embodiments. This description is not intended to limit the scope of claims but instead to provide examples of such embodiments. The following discussion therefore presents exemplary embodiments, which include a device for associating image areas with audio recordings and a method for using a user-programmable image holder having a touch-sensitive surface.

One embodiment of the device for associating image areas with audio recordings employs a user-programmable image holder having a touch-sensitive surface. The image holder may be of any surface allowing a user to associate an audio recording with a relevant image area. The image holder may have a form factor of a card, such as a greeting card, and may be made of two halves folding towards each other. The image area may be one or more hard copy photographic printouts that are attached to the image holder by methods typically used to attach printed photos to a photo album. The audio recording is associated with this image area and then stored in a memory that is embedded within the device. Note that the image area may be defined physically contacting an area on the touch-sensitive surface of the image holder itself or may be defined by contacting an area on a digital image monitor of an external device that the device is connected to, such that the are on the digital monitor represents a corresponding physical area on the touch-sensitive surface.

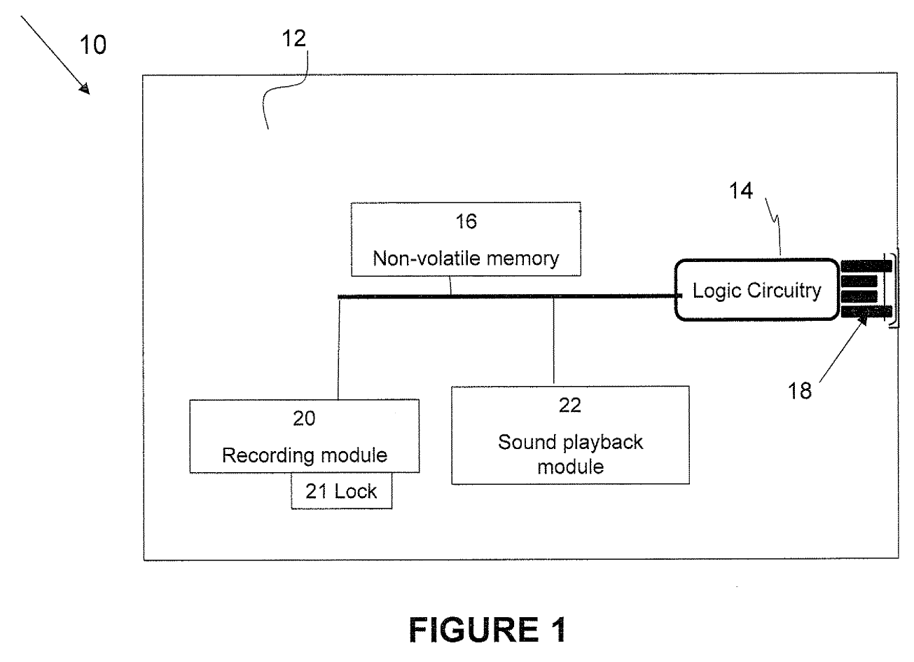

FIG. 1 is an exemplary block diagram of a device 10 for associating image areas with audio recordings. Device 10 includes a user-programmable image holder 12 having a touch-sensitive surface, logic circuitry 14 and a 16 non-volatile memory. The image holder 12 may have a form factor of a card, such as any greeting card, post card, etc. The touch-sensitive surface may be configured to comply with a touch-screen or a graphics tablet.

Logic circuitry 14 is configured within the image holder 12 and is operative to define at least one image area in response to physical contact applied to a selected image area on the touch-sensitive surface. A user may select his/her desired image area by touching one or more areas on the touch-sensitive surface. The selected area may be defined as pairs of points that are a polygon around the selected image area. Logic circuitry 14 is also operative to associate the selected image area with an audio signal. Non-volatile memory 16 is mounted within the image holder 12 and electrically connectable to the logic circuitry 14. The audio signals are stored in the non-volatile memory 16 in association with the selected image area. The audio signal may be a user-generated audio message or may be received from an external device.

A recording module 20, within the image holder 12 and electrically connectable to the logic circuitry 14, is operative to record audio messages. Recording module 20 may include a microphone. Touching the desired image area on the image holder may activate/deactivate the recording operation. Note that recording module 20 may be optionally configured with a locking mechanism 21 that is operative to disable the functionality of the recording module and to thereby prevent accidental recording of audio messages.

A sound playback module 22, within the image holder 12 and electrically connectable to the logic circuitry 14 is operative to audibly play the audio signals that are stored on the device. Sound playback module 22 may include a speaker. Touching the desired image area on the image holder may activate the playing operation.

The audio signals may optionally be received from an external device, such as a host computer. This may be applied via a connector 18 that is connectable to the logic circuitry 14 and is operative to connect the image holder 12 to the external device for communication therebetween. The connector 18 may be or may include a USB connector. The image area may be an image area on a monitor of the external device. Connecting the device 10 to the external device can be further applied for recording new audio signals into the non-volatile memory 16, for playing audio signals, etc.

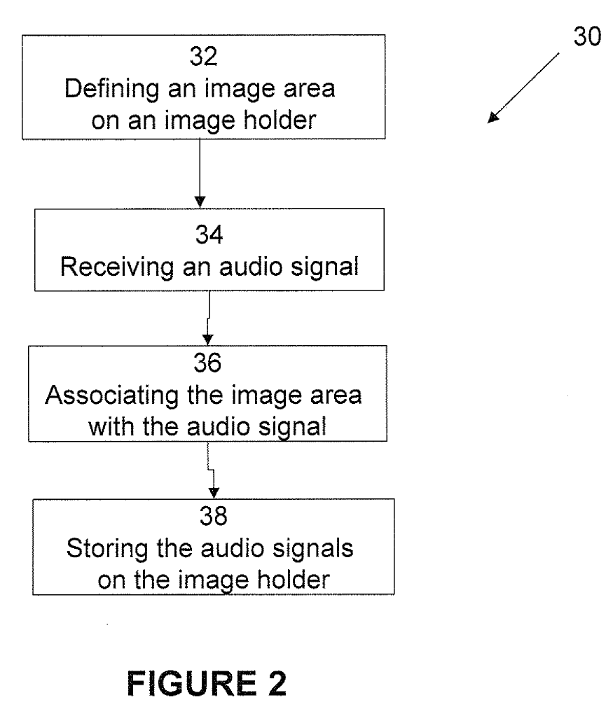

FIG. 2 illustrates an exemplary flow chart of a method 30 for associating image areas with audio recordings using a user-programmable image holder having a touch-sensitive surface. The initial step 32 includes defining, by the user-programmable image holder, at least one image area. The image area is defined in response to physical contact applied to this image area on the touch-sensitive surface. A user may define an image area by physically contacting an arbitrary shaped area on the image holder. Defining an image area as such may be useful when the desired image area is significantly larger than a finger. Another way for a user to define an image area is by physically touching one point on the image holder and then sliding his/her finger along a perimeter of the desired area. At 34 audio signals are received by the image holder. The audio signals may correspond to an audio message that is recorded by a user for the defined image area. At 36 the image area is associated with the audio signal. This may be applied, for example, by associating the audio signals to all the points (defined by their XY coordinates for example) within the perimeter of the defined area. Then, at 38, the audio signal is stored on the image holder.

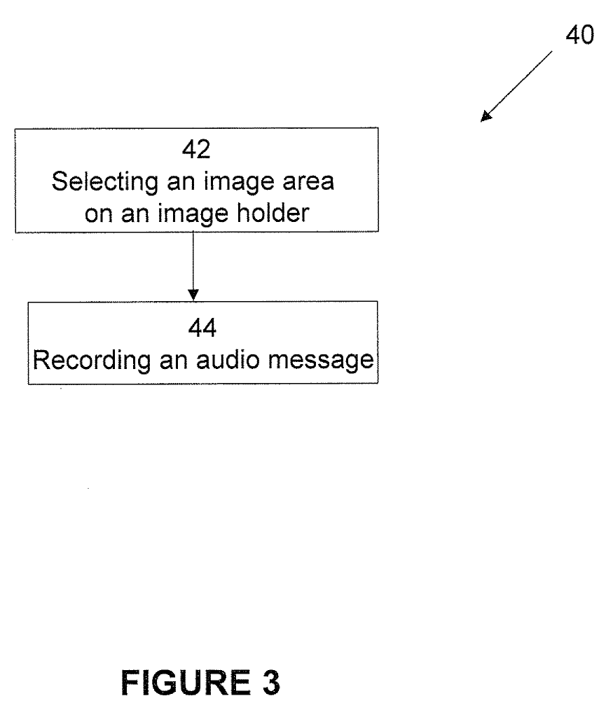

FIG. 3 illustrates an exemplary flow chart of a method 40 for using a user-programmable image holder having a touch-sensitive surface. At 42 a user (the image holder) selects an image area by physically contacting the image area on the touch-sensitive surface. The user may point to a part of an image area (a person, a part of a machine, a place in the scenery, etc.) by slightly pressing the image area with a finger. While pressing on the image area, the user may record a short audio clip that describes the selected image area (44). When the user lifts his/her finger from the image holder, the recording may end. The recording may be performed by a user physically contacting (or pointing to) the image area on the touch-sensitive surface and activating a voice recorder that records the user's voice, using a microphone for example, for as long as the physical contact continues. The recording may also be performed by communicating audio signals to a microphone and amplifier that are external to the device (upon connecting the user-programmable image holder to an external device, such as a host computer, for communication therebetween). After the audio signals are stored on the image holder, the user can then record more audio signals with respect to other image areas on the image holder or with respect to the same image area.

Having described various embodiments of a device and method, it is to be understood that the description is not meant as a limitation, since further modifications will now suggest themselves to those skilled in the art, and it is intended to cover such modifications as fall within the scope of the appended claims.

1. A device for associating image areas with audio recordings, the device comprising:
(a) a user-programmable image holder having a touch-sensitive surface;
(b) logic circuitry within said user-programmable image holder operative to define at least one image area in response to physical contact applied to said image area on said touch-sensitive surface, and to associate said at least one image area with an audio signal; and
(c) a non-volatile memory for storing said audio signal, said non-volatile memory mounted within said user-programmable image holder and electrically connectable to said logic circuitry.

2. The device of claim 1 further comprising:
(d) a recording module within said user-programmable image holder and electrically connectable to said logic circuitry, said recording module operative to record audio messages.

3. The device of claim 2, wherein said recording module includes a microphone.

4. The device of claim 1 further comprising:
(d) a sound playback module within said user-programmable image holder and electrically connectable to said logic circuitry, said sound playback module operative to audibly play said audio signal.

5. The device of claim 4, wherein said sound playback module includes a speaker.

6. The device of claim 1, wherein said audio signal is user-generated.

7. The device of claim 1 further comprising:
(d) a connector connectable to said logic circuitry, said connector operative to connect said user-programmable image holder to an external device for communication therebetween.

8. The device of claim 7, wherein said audio signal is received from said external device.

9. The device of claim 7, wherein said connector includes a USB connector.

10. The device of claim 7, wherein said at least one image area is an image area on a monitor of said external device.

11. The device of claim 1, wherein said touch-sensitive surface is configured to comply with a graphics tablet.

12. The device of claim 1, wherein said touch-sensitive surface is compatible to a touch screen.

13. The device of claim 1, wherein said user-programmable image holder has a form factor of a card.

14. A method for associating image areas with audio recordings using a user-programmable image holder having a touch-sensitive surface, the method comprising:
(a) defining, by the user-programmable image holder, at least one image area in response to physical contact applied to said at least one image area on the touch-sensitive surface;
(b) receiving an audio signal for said at least one image area; and
(c) associating, by the user-programmable image holder, said at least one image area with said audio signal.

15. The method of claim 14 further comprising:
(d) storing said audio signal, by the user-programmable image holder.

16. A method for using a user-programmable image holder having a touch-sensitive surface, the method comprising:
(a) selecting at least one image area on the user-programmable image holder, in response to physical contact applied to said image area on the touch-sensitive surface; and
(b) recording an audio message in association with said at least one image area.

17. The method of claim 16 further comprising:
(c) generating, by a user, said audio message.

18. The method of claim 16 further comprising:
(c) connecting the user-programmable image holder to an external device for communication therebetween.
